(19) United States
(12) Patent Application Publication
(10) Pub. No.: US 2018/0300029 A1
(43) Pub. Date: Oct. 18, 2018

(54) Smart Bookmarks For Viewing Content

(71) Applicant: International Business Machines Corporation, Armonk, NY (US)

(72) Inventors: Ting Cao, Beijing (CN); ZiJian Ji, Tianjin (CN); He Li, Beijing (CN); Pan Li, Beijing (CN); Jiandong Yin, Beijing (CN)

(21) Appl. No.: 15/900,909

(22) Filed: Feb. 21, 2018

Related U.S. Application Data
(63) Continuation of application No. 15/488,766, filed on Apr. 17, 2017.

(51) Int. Cl. G06F 3/0483; G06T 1/00; G06F 3/0482; G06F 17/30

(52) U.S. Cl. CPC G06F 3/0483; G06T 1/0007; G06T 2200/24; G06F 17/30884; G06F 3/0482

(57) ABSTRACT

An indication is received from a user to create a bookmark for an application. A screen capture mode is enabled on a display of the device. An input is received from the user to capture a portion of the display. Information about the captured portion of the display is determined. The captured portion of the display and the information is stored as a bookmark.

### BACKGROUND

The present invention relates generally to the field of viewing content on a device, and more particularly to creating smart bookmarks to simplify viewing content on a device.

Mobile devices are used for many tasks—making calls, communicating via e-mail and social media, organization using calendars and to-do lists, listening to music, playing games, looking at the Internet, and the list goes on and on. Because of the usefulness of mobile devices, ownership of mobile devices continues to rise. Technology included in mobile devices continues to improve making the mobile devices faster, smaller, lighter, and with better display screens for viewing.

### SUMMARY OF THE INVENTION

Embodiments of the present invention include an approach for creating bookmarks for viewing content on a device. In one embodiment, an indication is received from a user to create a bookmark for an application. A screen capture mode is enabled on a display of the device. An input is received from the user to capture a portion of the display. Information about the captured portion of the display is determined. The captured portion of the display and the information is stored as a bookmark.

### BRIEF DESCRIPTION OF THE DRAWINGS

FIG. 1 depicts a functional block diagram of a computing environment, in accordance with an embodiment of the present invention;

FIG. 2 depicts a flowchart of a program for creating smart bookmarks to simplify viewing content on a mobile device, in accordance with an embodiment of the present invention;

FIG. 3 depicts an example mobile device showing possible content from a first application that a user may want to bookmark, in accordance with an embodiment of the present invention;

FIG. 4 depicts an example bookmark, in accordance with an embodiment of the present invention;

FIG. 5 depicts an example mobile device showing a second application and a previously created bookmark, in accordance with an embodiment of the present invention; and

FIG. 6 depicts a block diagram of components of the computing environment of FIG. 1, in accordance with an embodiment of the present invention.

### DETAILED DESCRIPTION

Embodiments of the present invention provide for creating smart bookmarks to simplify viewing content on a mobile device. Reading a novel or viewing content, such as a long news article, on a mobile device (e.g., a smartphone, a phablet, or a tablet) can be difficult due to the smaller display size on the mobile device when compared to a desktop computer with one, or sometimes more than one, large display. Scrolling back and forth to re-read a section, refer to a figure, or to locate a particular topic of discussion can be inconvenient and time consuming because of the small screen size.

Embodiments of the present invention recognize that there is an approach for creating smart bookmarks to simplify viewing content on a mobile device. In an embodiment, smart bookmarks may be created by a user to facilitate finding content in a simple, straightforward manner. In an embodiment, the user may create one or more smart bookmarks by capturing a partial or full (i.e., entire) screenshot of a mobile device. In the embodiment, the one or more smart bookmarks may include an identification (ID), the name of the application (app) currently in use, the type of app, a global positioning system (GPS) location, and information added by the user.

The present invention will now be described in detail with reference to the Figures.

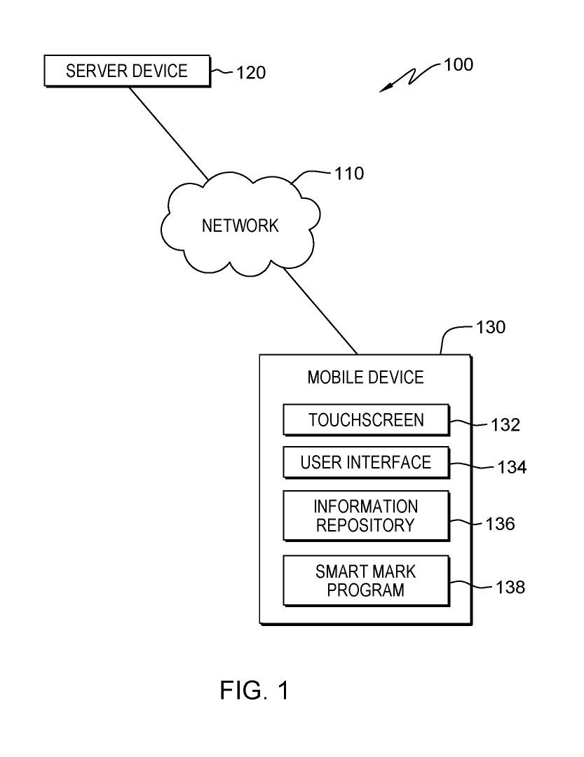

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes server device 120 and mobile device 130 connected to network 110. In example embodiments, computing environment 100 may include other computing devices (not shown in FIG. 1) such as smartwatches, cell phones, smartphones, wearable technology, phablets, tablet computers, laptop computers, desktop computers, other computer servers or any other computer system known in the art, interconnected with server device 120 and mobile device 130 over network 110.

In an embodiment of the present invention, server device 120 and mobile device 130 connect to network 110, which enables server device 120 and mobile device 130 to access other computing devices and/or data not directly stored on server device 120 and mobile device 130. Network 110 may be, for example, a short-range, low power wireless connection, a local area network (LAN), a telecommunications network, a wide area network (WAN) such as the Internet, or any combination of the three, and include wired, wireless, or fiber optic connections. Network 110 may include one or more wired and/or wireless networks that are capable of receiving and transmitting data, voice, and/or video signals, including multimedia signals that include voice, data, and video information. In general, network 110 can be any combination of connections and protocols that will support communications between server device 120, mobile device 130, and any other computing devices connected to network 110, in accordance with embodiments of the present invention. In an embodiment, data received by another computing device (not shown in FIG. 1) in computing environment 100 may be communicated to server device 120 and mobile device 130 via network 110.

In embodiments of the present invention, server device 120 may be a laptop, tablet, or netbook personal computer (PC), a desktop computer, a personal digital assistant (PDA), a smartphone, a standard cell phone, a phablet, a smart-watch or any other wearable technology, or any other programmable electronic device capable of communicating with any other computing device within computing environment 100. In an embodiment, computing environment 100 includes any number of server device 120.

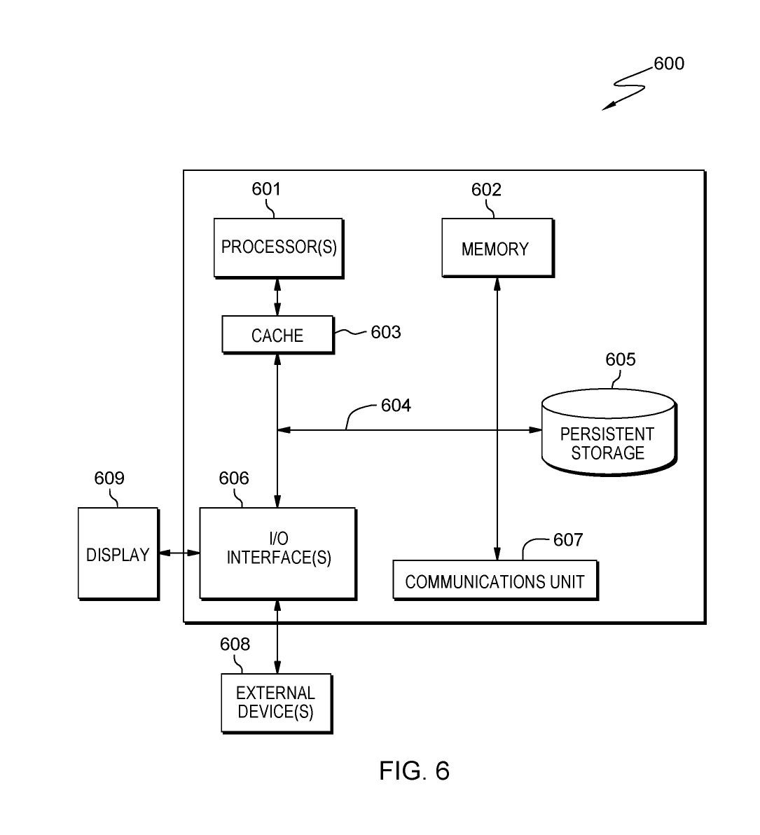

In certain embodiments, server device 120 represents a computer system utilizing clustered computers and components (e.g., database server computers, application server computers, etc.) that act as a single pool of seamless resources when accessed by elements of computing environment 100. In general, server device 120 is representative of any electronic device or combination of electronic devices capable of executing computer readable program instructions. Server device 120 may include components as depicted and described in further detail with respect to FIG. 6, in accordance with embodiments of the present invention. In an embodiment, server device 120 is a website server that provides content to mobile device 130.

According to an embodiment of the present invention, mobile device 130 includes touchscreen 132, user interface 134, information repository 136, and smart mark program 138. In an embodiment, mobile device 130 may be a laptop, tablet, or netbook personal computer (PC), a desktop computer, a personal digital assistant (PDA), a smartphone, a standard cell phone, a phablet, a smart-watch or any other wearable technology, or any other hand-held programmable electronic device capable of communicating with any other computing device within computing environment 100. In an embodiment, mobile device 130 is substantially similar to server device 120. While mobile device 130 is referenced herein, it should be noted that mobile device 130 may be any type programmable electronic device, and not merely a hand-held or mobile device.

According to various embodiments of the present invention, touchscreen 132 is a technology used in conjunction with user interface 134, allowing mobile device 130 to accept user input. Touchscreens are included in many electronic devices such as game consoles, tablet computers, phablets, smartphones, PDAs, and the like. In example embodiments, touchscreen 132 may include the following technologies: resistive; surface acoustic wave; capacitive, including surface capacitance; projected capacitance; mutual capacitance; self-capacitance; infrared grid; infrared acrylic projection; optical imaging; dispersive signal technology; acoustic pulse recognition; and the like. In one embodiment, touchscreen 132 may include haptic feedback, an example of which is a vibratory response to the touch of user interface 134.

In an embodiment, user interface 134 provides an interface between a user of mobile device 130, network 110 and any other devices connected to network 110. User interface 134 allows a user of mobile device 130 to interact with the Internet and also enables the user to receive an indicator of one or more previous viewing locations and a summary of viewing history on the Internet. In general, a user interface is the space where interactions between humans and machines occur. User interface 134 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 134 may also be mobile application software that provides an interface between a user of mobile device 130 and network 110. Mobile application software, or an “app,” is a computer program designed to run on smartphones, phablets, tablet computers and other mobile devices.

According to embodiments of the present invention, information repository 136 may be storage that may be written to and/or read by smart mark program 138. In one embodiment, information repository 136 resides on mobile device 130. In another embodiment, information repository 136 resides on server device 120. In yet other embodiments, information repository 136 may reside on any other device (not shown in FIG. 1) in computing environment 100, in cloud storage or on another computing device accessible via network 110. In yet another embodiment, information repository 136 may represent multiple storage devices within mobile device 130. Examples of data stored to information repository 136 include an operating system (OS) for mobile device 130, mobile apps (e.g., e-mail apps, calendar apps, game apps, sports apps, banking apps, weather apps, productivity apps, shopping apps, news apps, and the like), user data such as contact information (e.g., names, addresses, phone numbers, etc.) for acquaintances of the user, music files, picture files, video files, web browsers, and bookmark information created by smart mark program 138.

In an embodiment, information repository 136 may be implemented using any volatile or non-volatile storage media for storing information, as known in the art. For example, information repository 136 may be implemented with a tape library, optical library, one or more independent hard disk drives, multiple hard disk drives in a redundant array of independent disks (RAID), solid-state drives (SSD), or random-access memory (RAM). Similarly, information repository 136 may be implemented with any suitable storage architecture known in the art, such as a relational database, an object-oriented database, or one or more tables. In an embodiment of the present invention, smart mark program 138 and any other programs and applications (not shown) operating on mobile device 130 may store, read, modify, or write data to information repository 136.

According to embodiments of the present invention, smart mark program 138 may be a program, a subprogram of a larger program, an application, a plurality of applications, or mobile application software, which functions to create smart bookmarks to simplify viewing content on a mobile device. A program is a sequence of instructions written by a programmer to perform a specific task. Smart mark program 138 may run by itself but may be dependent on system software (not shown in FIG. 1) to execute. In one embodiment, smart mark program 138 functions as a stand-alone program residing on mobile device 130. In another embodiment, smart mark program 138 may work in conjunction with other programs, applications, etc., found in computing environment 100. In yet another embodiment, smart mark program 138 may be found on server device 120 or on other computing devices (not shown in FIG. 1) in computing environment 100, which are interconnected to mobile device 130 via network 110.

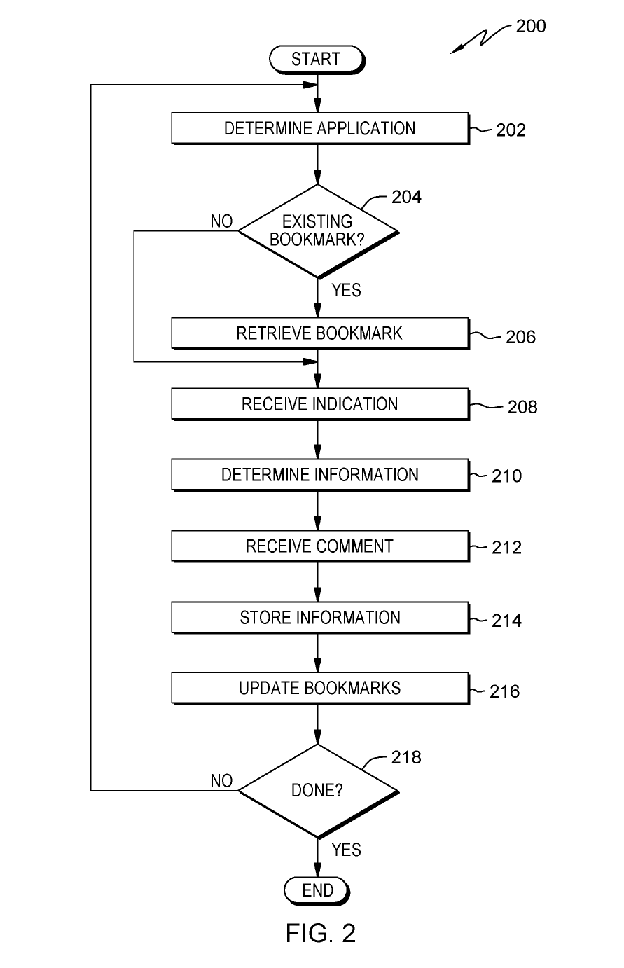

FIG. 2 is a flowchart of workflow 200 depicting an approach for creating smart bookmarks to simplify viewing content on a mobile device. In one embodiment, the method of workflow 200 is performed by smart mark program 138. In an alternative embodiment, the method of workflow 200 may be performed by any other program working with smart mark program 138. In an embodiment, a user, via user interface 134 may invoke workflow 200 upon opening an application on mobile device 130. In an alternative embodiment, a user may invoke workflow 200 upon accessing smart mark program 138.

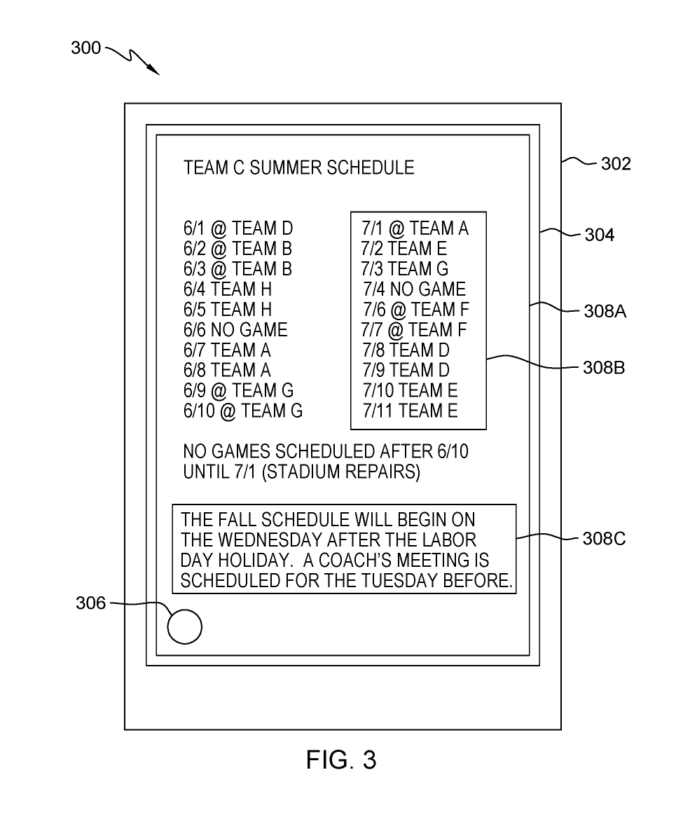

In an embodiment, smart mark program 138 determines application (step 202). In other words, smart mark program 138 determines the name of the current mobile application (app) in use by a user. According to embodiments of the present invention, smart mark program 138 determines the application so that any bookmarks created by the user are tagged with the application name. In an embodiment, smart mark program 138 is operating in the background and is available. In another embodiment, smart mark program 138 needs to be turned on by opening an application, by tapping an icon such as smart mark icon 306 in FIG. 3, or by any other method known in the art. In an embodiment, smart mark program 138 determines the app name by checking the available metadata for the app being used by the user. In an embodiment, smart mark program 138 determines the name of the app (not shown in FIG. 1) displayed on touchscreen 132 on mobile device 130. For example, “Bill” is looking at a sports app on a smartphone to check the schedule of a favorite team.

In an embodiment, smart mark program 138 determines whether there are existing bookmarks (decision step 204). In other words, smart mark program 138 determines whether previously existing bookmarks related to the current in use app are stored to memory. In an embodiment (decision step 204, NO branch), smart mark program 138 determines that there are not existing bookmarks related to the current in use app stored to memory; therefore, smart mark program 138 proceeds to step 208 to receive an indication from the user. In the embodiment (decision step 204, YES branch), smart mark program 138 determines that there are existing bookmarks related to the current in use app stored to memory; therefore, smart mark program 138 proceeds to step 206.

In an embodiment, smart mark program 138 retrieves a bookmark (step 206). In other words, smart mark program 138 will retrieve, from memory, previously stored bookmarks related to the current in use app. In an embodiment, bookmarks related to the current in use app are moved from the disk file system to cache memory so that retrieval time for the related bookmarks is improved. According to embodiments of the present invention, the retrieved bookmarks may be from the same app, from a similar app (e.g., all bookmarks from sports apps, all bookmarks from financial apps, etc.), bookmarks with similar user tags, and bookmarks with similar content. In an embodiment, bookmark content is determined by analyzing the bookmark using natural language processing (NLP) and cognitive analysis. In an embodiment, NLP is a field of computer science, artificial intelligence, and computational linguistics concerned with the interactions between computers and human (natural) languages, in both common language and regional slang (i.e., informal language). As such, NLP is related to the area of human-computer interaction. Many challenges in NLP involve natural language understanding, that is, enabling computers to derive meaning from human or natural language input, and others involve natural language generation. In an embodiment, cognitive analysis involves self-learning systems that use data mining, pattern recognition and NLP to mimic the way the human brain works. The goal of cognitive analysis is to create automated information technology systems that are capable of solving problems without requiring human assistance. Cognitive analysis systems use machine learning algorithms. Such systems continually acquire knowledge from the data fed into them by mining data for information. The systems refine the way they look for patterns and as well as the way they process data so they become capable of anticipating new problems and modeling possible solutions. In an embodiment, smart mark program 138 retrieves related, previously created, bookmarks stored to information repository 136 on mobile device 130. For example, since “Bill” is looking at a sports app on a smartphone, previously created bookmarks related to sports are retrieved from memory.

In an embodiment, smart mark program 138 receives an indication (step 208). In other words, smart mark program 138 receives a first indication from a user to create a bookmark. According to embodiments of the present invention, the indication from the user may be received based on the user tapping an icon on a touchscreen, the user shaking a mobile device, the user speaking an instruction, or any other type of indication known in the art. In an embodiment, after receiving the first indication, smart mark program 138 prepares to create a bookmark by opening a screen capture mode on the display of the mobile device. In an embodiment, the screen capture may include the entire screen. In another embodiment, the screen capture may include only a portion of the screen as determined by the user re-sizing the capture screen by dragging the edges of the screen with a single finger or increasing/decreasing the size of the capture screen using two fingers. In an embodiment, after re-sizing the capture screen, the user is able to relocate the capture screen to the desired location by placing a finger inside the capture screen or on an edge of the capture screen and dragging the capture screen to the desired location. According to an embodiment of the present invention, the resizing and relocating of the capture screen is repeated until the four sides of the capture screen encompass the content desired by the user. In an embodiment, smart mark program 138 receives a second indication from the user to complete the screen capture. The second indication may be any type of previously discussed indication. According to an embodiment of the present invention, the screen capture is stored as a vector image so the user is able to zoom in and zoom out of the vector image without distortion of the vector image. In an embodiment, smart mark program 138 receives a first indication from a user by the user single tapping an icon displayed on touchscreen 132 on mobile device 130. In the embodiment, smart mark program 138 resizes and relocates the capture screen based on inputs of the user on touchscreen 132. In the embodiment, smart mark program 138 receives a second indication from the user to complete the screen capture. For example, referencing example mobile device 300 in FIG. 3, “Bill” taps smart mark icon 306 on display 304 of smartphone 302 to activate screen capture 308A (i.e., the full screen). Potential screen captures available to “Bill” also include screen capture 308B and screen capture 308C. “Bill” resizes and relocates the capture screen to encompass screen capture 308B displayed in the sports app. “Bill” taps smart mark icon 306 a second time to complete the screen capture.

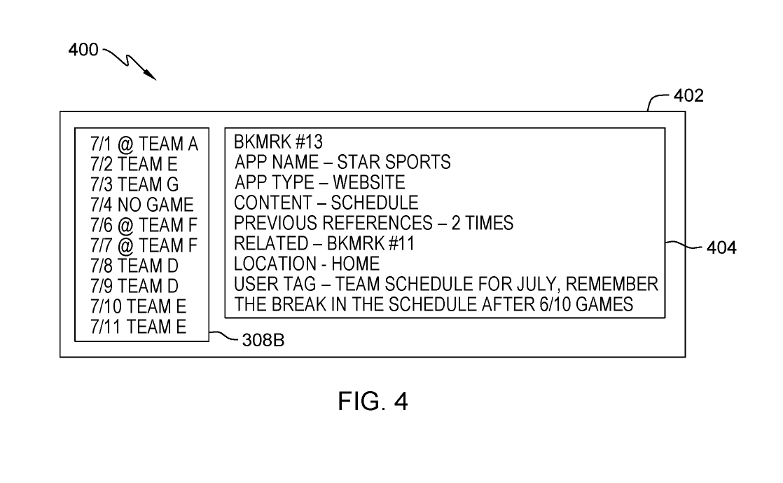

In an embodiment, smart mark program 138 determines information (step 210). In other words, smart mark program 138 determines the information pertinent to the completed screen capture. The pertinent information may include, for example, the previously determined app name, a bookmark identification (e.g., a number, a letter, an alphanumeric, etc.), a type of app, content of the screen capture, a number of times the bookmark has been referenced, related bookmarks, and a location of the user when the bookmark is created. In an embodiment, the determination of the app name is done via the app metadata. In an embodiment, the determination of the bookmark identification is done by checking the memory of the mobile device for the stored bookmarks. In an embodiment, the determination of the content of the screen capture is made by analyzing the screen capture using cognitive analysis and natural language processing. In an embodiment, the determination of the number of times the bookmark has been referenced and the related bookmarks is done by checking the memory of the mobile device. In an embodiment, the determination of the location is done via a global positioning system (GPS) included on the mobile device. For example, a user may drive past a unique antique store and stop to search for the antique store on a mobile device. The user can create a bookmark for the antique store, which will include the GPS location of the antique store, so the user is able to find the antique store at a later date via the bookmark or send the location of the antique store to a friend. According to an embodiment of the present invention, smart mark program 138 determines the pertinent information of the screen capture. For example, information 404 in FIG. 4 regarding the team schedule screen capture performed by “Bill” is determined.

In an embodiment, smart mark program 138 receives a comment (step 212). In other words, smart mark program 138 receives a comment from the user concerning the screen capture. According to an embodiment of the present invention, the comment from the user may be received by the user inputting the comment via a user interface (e.g., a keyboard). According to another embodiment of the present invention, the comment from the user may be received by the user inputting the comment via a microphone. In an embodiment, smart mark program 138 receives a comment from the user via user interface 134 displayed on touchscreen 132 on mobile device 130. For example, “Bill” types on a keyboard, displayed on a smartphone, the user tag information (e.g., “Team schedule for July, remember the break in the schedule after 6/10 games”) included in information 404 in FIG. 4.

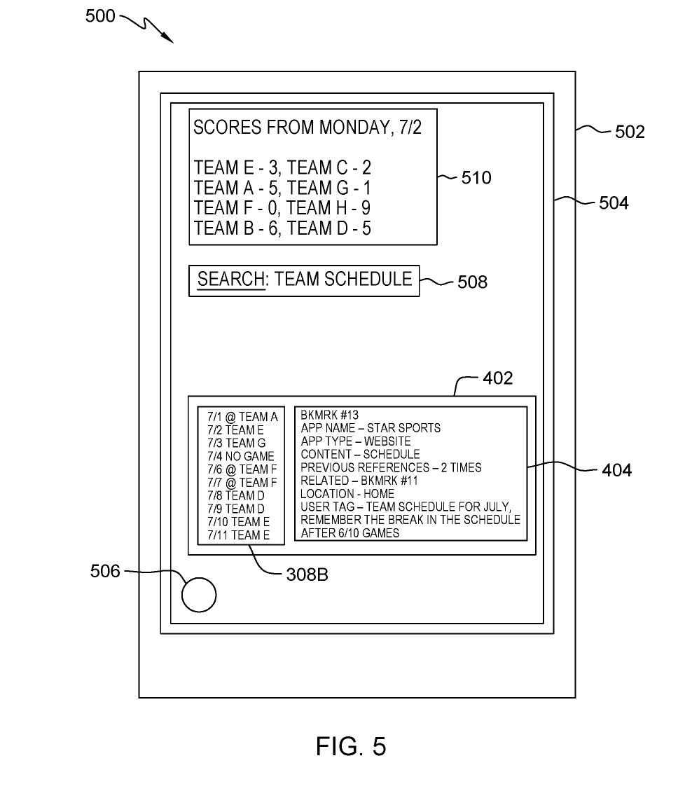

In an embodiment, smart mark program 138 stores information (step 214). In other words, smart mark program 138 stores the full or partial screen capture, the determined information, and the user comments to a memory on the mobile device. According to an embodiment of the present invention, the stored information results in the creation of a new bookmark. According to another embodiment of the present invention, the stored information results in an update of an existing bookmark. In an embodiment, smart mark program 138 stores the determined information and user comments to information repository 136 on mobile device 130. For example, referencing example bookmark 400 in FIG. 4, information 404 stored for bookmark 402 created by “Bill” includes team schedule 308B (in FIG. 3, FIG. 4, and FIG. 5), a bookmark identification, the app name “Bill” used to look at the schedule, the type of app, the content, the number of previous references for the bookmark, any related bookmarks, the location where the bookmark was created, and the comments made by “Bill”.

In an embodiment, smart mark program 138 updates the bookmarks (step 216). In other words, smart mark program 138 updates the list of bookmarks stored to memory based on the newly created bookmark or the newly updated existing bookmark. In an embodiment, smart mark program 138 updates all of the bookmarks based on the relevance of the bookmarks. In an embodiment, relevance of bookmarks is based on whether the bookmarks are from the same app, from the same app type, or include the same content. In an embodiment, smart mark program 138 updates the bookmarks stored to information repository 136 on mobile device 130 with the newly created bookmark. For example, the sports related bookmarks created by “Bill” are updated in the memory of the smartphone.

In an embodiment, smart mark program 138 determines whether the user is finished (decision step 218). In other words, smart mark program 138 determines whether the user is finished creating bookmarks for the current application in use by the user. In an embodiment, the determination may be made by receiving an indication from the user such as the user pressing and holding the smart mark icon. In another embodiment, the determination may be made by a period of inactivity (e.g., three minutes, five minutes, ten minutes, etc.) by the user on the mobile device. In an embodiment (decision step 218, NO branch), smart mark program 138 determines that the user is not finished; therefore, smart mark program 138 proceeds to step 202 to determine the application in use by the user. In the embodiment (decision step 218, YES branch), smart mark program 138 determines that the user is finished; therefore, smart mark program 138 ends.

FIG. 5 depicts example mobile device 500 displaying scores 510 on smartphone 502 via display 504 and a previously created bookmark (i.e., bookmark 402, also found in FIG. 4). For example, “Bill” is checking the scores for the games played on the second of July. “Bill” sees that his favorite team C lost to team E by a score of 3 to 2. “Bill” is interested in seeing who the opponent is for team C in the next game. “Bill” taps smart mark icon 506 in FIG. 5 to open the smart mark program. The smart mark program determines that “Bill” is using a sport app so therefore, the smart mark program retrieves related bookmarks such as bookmark 402 (in both FIG. 4 and FIG. 5). Bookmark 402 includes team schedule 308B so that “Bill” is able to see the next opponent for team C on the third of July. In another example, “Bill” does a quick double tap on smart mark icon 506 which launches search field 508. Here, “Bill” is able to enter a search term to look for other stored bookmarks or to find additional information in either the current app or in a different app.

FIG. 6 depicts computer system 600, which is an example of a system that includes smart mark program 138. Computer system 600 includes processors 601, cache 603, memory 602, persistent storage 605, communications unit 607, input/output (I/O) interface(s) 606 and communications fabric 604. Communications fabric 604 provides communications between cache 603, memory 602, persistent storage 605, communications unit 607, and input/output (I/O) interface(s) 606. Communications fabric 604 can be implemented with any architecture designed for passing data and/or control information between processors (such as microprocessors, communications and network processors, etc.), system memory, peripheral devices, and any other hardware components within a system. For example, communications fabric 604 can be implemented with one or more buses or a crossbar switch.

Memory 602 and persistent storage 605 are computer readable storage media. In this embodiment, memory 602 includes random access memory (RAM). In general, memory 602 can include any suitable volatile or non-volatile computer readable storage media. Cache 603 is a fast memory that enhances the performance of processors 601 by holding recently accessed data, and data near recently accessed data, from memory 602.

Program instructions and data used to practice embodiments of the present invention may be stored in persistent storage 605 and in memory 602 for execution by one or more of the respective processors 601 via cache 603. In an embodiment, persistent storage 605 includes a magnetic hard disk drive. Alternatively, or in addition to a magnetic hard disk drive, persistent storage 605 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 605 may also be removable. For example, a removable hard drive may be used for persistent storage 605. Other examples include optical and magnetic disks, thumb drives, and smart cards that are inserted into a drive for transfer onto another computer readable storage medium that is also part of persistent storage 605.

Communications unit 607, in these examples, provides for communications with other data processing systems or devices. In these examples, communications unit 607 includes one or more network interface cards. Communications unit 607 may provide communications through the use of either or both physical and wireless communications links. Program instructions and data used to practice embodiments of the present invention may be downloaded to persistent storage 605 through communications unit 607.

I/O interface(s) 606 allows for input and output of data with other devices that may be connected to each computer system. For example, I/O interface 606 may provide a connection to external devices 608 such as a keyboard, keypad, a touchscreen, and/or some other suitable input device. External devices 608 can also include portable computer readable storage media such as, for example, thumb drives, portable optical or magnetic disks, and memory cards. Software and data used to practice embodiments of the present invention can be stored on such portable computer readable storage media and can be loaded onto persistent storage 605 via I/O interface(s) 606. I/O interface(s) 606 also connect to display 609.

Display 609 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method for creating bookmarks for viewing content on a device, the method comprising:
receiving, by one or more computer processors, an indication from a user to create a bookmark for an application on a device, wherein the device has a touchscreen;
enabling, by one or more computer processors, a screen capture mode on a display of the device;
receiving, by one or more computer processors, input from the user to capture a portion of the display, wherein receiving the input from the user to capture the portion of the display, comprises:
receiving one or more inputs from the user to size and locate the portion of the display; and
receiving input from the user to complete the capture of the portion of the display;
determining, by one or more computer processors, information about the captured portion of the display, wherein the information comprises a name of the application, a type of application, content of the screen capture, a number of related bookmarks, and a location of the user when the bookmark is created;
receiving, by one or more computer processors, a comment about the captured portion of the display from the user;
storing, by one or more computer processors, the captured portion of the display and the information as a bookmark, wherein the bookmark further comprises the comment about the captured portion of the display;
updating, by one or more computer processors, a list of bookmarks based on the relevance of each bookmark, of the list of bookmarks, to content currently viewed by the user; and
retrieving, by one or more computer processors, a stored bookmark from a memory of the device, wherein the stored bookmark is related to the application.
